(19) United States
(12) Patent Application Publication
(10) Pub. No.: US 2015/0013818 A1
(43) Pub. Date: Jan. 15, 2015

(54) Multilayer Film for a Skirt of a Flexible Tube and Associated Flexible Tube

(71) Applicant: Albea Services, Gennevilliers (FR)

(72) Inventors: Philip Ashman, Gennevilliers (FR); John Suter, Gennevilliers (FR); Jean-Claude Jammet, Gennevilliers (FR)

(73) Assignee: Albea Services, Gennevilliers (FR)

(21) Appl. No.: 14/373,159

(22) PCT Filed: Jan. 21, 2013
(86) PCT No.: PCT/EP2013/051018

§ 371 Date: Jul. 18, 2014

(30) Foreign Application Priority Data
Jan. 19, 2012 (FR) 1250562

(51) Int. Cl. F16L 11/00; B32B 15/08; B32B 1/08; B32B 15/20; B32B 27/08; B32B 27/32

(52) U.S. Cl. CPC F16L 11/00; B32B 27/08; B32B 27/32; B32B 1/08; B32B 15/20; B32B 15/08; B32B 2597/00; B32B 2307/518; B32B 2307/31
USPC 138/109; 428/349

(57) ABSTRACT

The invention proposes a film (1) for a skirt (2) of a flexible tube (3) one end of which is intended to be closed by a tube head (4), said multilayer film being intended to be folded on itself and heat-sealed along the length of a longitudinal seal line (6) in such a way as to form the skirt (2) so that a first layer (10) of the multilayer film (1), known as the inner layer, is heat-sealed to a second layer (20) of the multilayer film (1) opposite the first layer, known as the outer layer, characterised in that: —the inner layer (10) comprises a polymer or a blend of polymers with a Young's modulus of at least 1600 MPa, and—the outer layer (20) is made of a biaxially-oriented film.

The invention generally concerns flexible tubes of plastic material intended for the storage and distribution of liquid to pasty products, and more specifically the skirts of these flexible tubes and the multilayer films forming the same.

There is currently a trend in the flexible tube industry towards reducing the thickness of the films from which tubes are made, in order to reduce their overall manufacturing cost.

To that end, document US 2008/286512 describes a multilayer laminate comprising a layer of buried aluminium, surrounded on either side by an oriented co-extruded protective layer.

Document JP 10181755 describes a multilayer laminate film comprising a layer of biaxially-oriented polyethylene terephthalate (PET) approximately 12 μm thick laminated either side of a sheet of aluminium approximately 50 μm thick via an adhesive layer of urethane. A layer of non-oriented low-density polyethylene (LDPE) film approximately 30 μm thick is then laminated via an adhesive layer of urethane onto both layers of polyethylene terephthalate so as to form a multilayer film. The film thus obtained therefore has a good resistance to embossing, to heat and to stress-cracking.

Application DK 530482 proposes a polymer-based multilayer structure adapted for the production of tubes, having good impact resistance because of the incorporation of a layer of oriented polypropylene. The structure also includes a layer of linear low-density polyethylene which allows the lateral seal of the tube to be produced by heat-sealing and has good resistance to stress-cracking and corrosion.

These three documents propose the use of a layer with a relatively high level of rigidity, for example a layer of oriented polypropylene, in order to reduce the thickness of the multilayer film whilst giving it an acceptable overall level of stiffness. The thickness of the films obtained in this way is therefore in the approximate range between 150 μm and 190 μm.

However, these multilayer films are often difficult to seal. This is because they include a sealing layer that is very thin (approximately equal to a few microns) in order to reduce the final thickness of the film as much as possible, the result of which is that the seal is not as strong in comparison with conventional films, whether at the seal line itself or at the local surface of the tube that is sealed.

The present invention therefore proposes a multilayer film for a skirt of a flexible tube, one end of which is intended to be closed by a tube head, such as a tube of cream, which, for the same thickness, has a greater degree of stiffness and better heat-sealing properties than conventional films, in order, in particular, to reduce the manufacturing costs of the skirt and reduce the quantity of material in the packaging, but without weakening the skirt.

For this, the invention proposes a multilayer film for a skirt of a flexible tube of which one end is intended to be closed by a tube head, said multilayer film being intended to be folded on itself and heat-sealed along a longitudinal seal line so that the skirt is formed in such a way that a first layer of the multilayer film, known as the inner layer, is sealed to a second layer of the multilayer film opposite the first layer, known as the outer layer, characterised in that:
the inner layer includes a polymer or a blend of polymers with a Young's modulus of at least 1600 MPa, and
the outer layer is formed of a biaxially-oriented film.

Certain preferred but non-restrictive aspects of the multilayer film according to the invention are as follows:
the polymer and the biaxially-oriented film are chosen so that, once the inner layer has been heat-sealed to the outer layer, the seal line resists high levels of tensile stress;
the polymer or the blend of polymers also has good heat-sealing properties;
the polymer or the blend of polymers is also compatible with polyolefins such as polyethylene (PE), polyethylene copolymers, polypropylene (PP) and polypropylene copolymers, in order to minimise the risk of weakening (and therefore cracking) the layer;
the polymer or the blend of polymers with a Young's modulus includes at least one of the following materials: cyclic olefin copolymer (COC), cyclic olefin polymer (COP), polystyrene (PS), polyamide (PA), ethylene vinyl acetate copolymer (EVA), ethylene methacrylate copolymer (EMA), polylactic acid (PLA), polyhydroxyalkanoate (PHA), polyhydroxybutyrate (PHB), poly(butylene succinate) (PBS);
the inner layer includes a blend of a polymer possessing good heat-sealing properties with a polymer or a blend of polymers that has a Young's modulus of at least 2000 MPa;
the film comprises the following successive layers, from the inner layer to the outer layer: a blend of a high-density polyethylene (HDPE) and a cyclic olefin copolymer (COC) (10), binder, aluminium foil, binder, polyethylene (PE), biaxially-oriented film such as an oriented polypropylene (OPP) (20);
the inner layer consists of a first sub-layer, comprising a polymer or a blend of polymers with a Young's modulus of at least 1600 MPa, and of a second sub-layer, produced from a material with good heat-sealing properties;
the film comprises the following successive layers, from the inner layer to the outer layer: polyethylene (PE), cyclic olefin copolymer (COC), binder, aluminium foil, binder, polyethylene (PE), biaxially-oriented film such as an oriented polypropylene (OPP);
the binder is an extrusion binder, for example ethylene acrylic acid (EAA), ethylene methacrylate (EMA), ethylene ethyl acrylate (EEA), ethylene maleic anhydride copolymers, acrylic derivatives, or maleic anhydride grafted polyolefins, and
the outer layer is made of one of the following materials: oriented polypropylene (OPP), polyimide (PA), polyethylene terephthalate (PET), polyacrylonitrile (PAN), polyester naphthalate (PEN), polycarbonate (PC) or any multilayer of biaxially-oriented materials with an outer layer (20) capable of being heat-sealed to the material constituting the inner layer.

According to a second aspect, the invention also proposes a skirt for a flexible tube of which one end is intended to be closed by a tube head, a tube of cream for example, characterised in that it is made of a multilayer film as described above, and a flexible tube capable of comprising a skirt of this kind, closed at a first end by a tube head, and closed at a second end, opposite the first end, by heat-sealing.

Other features, aims and advantages of the present invention will become more clearly apparent on reading the detailed description that follows, and on examining the appended drawings given as a non-restrictive example, and in which:

FIG. 1 shows an embodiment of a multilayer film according to the invention; and

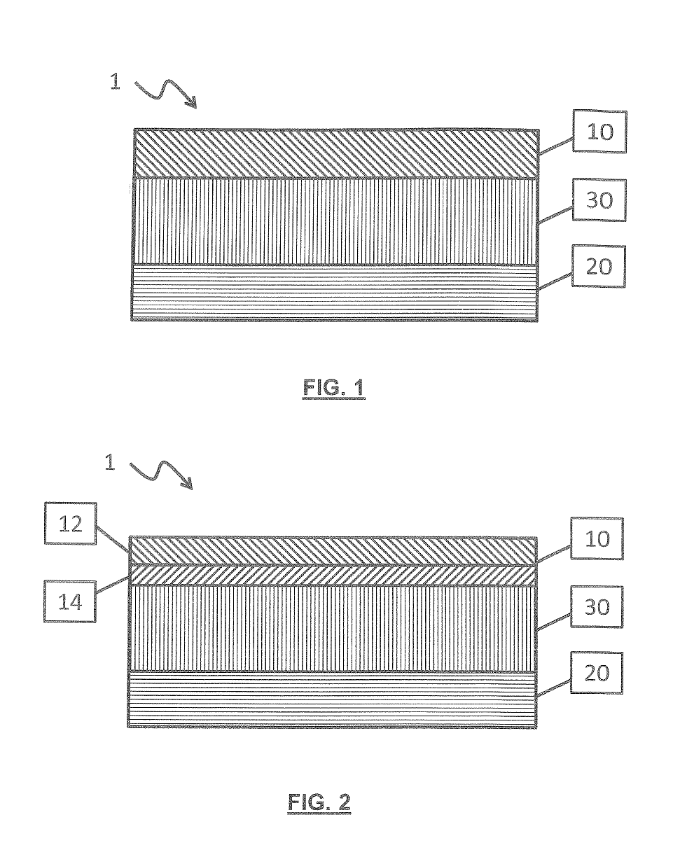

FIG. 2 shows a tube capable of comprising an embodiment of a skirt made with an embodiment of a multilayer film according to the invention; and

FIG. 3a shows an embodiment of a tube head joined to a skirt according to an embodiment of the invention;

FIG. 3b shows an embodiment of a tube head moulded from a casting onto a skirt according to an embodiment of the invention; and

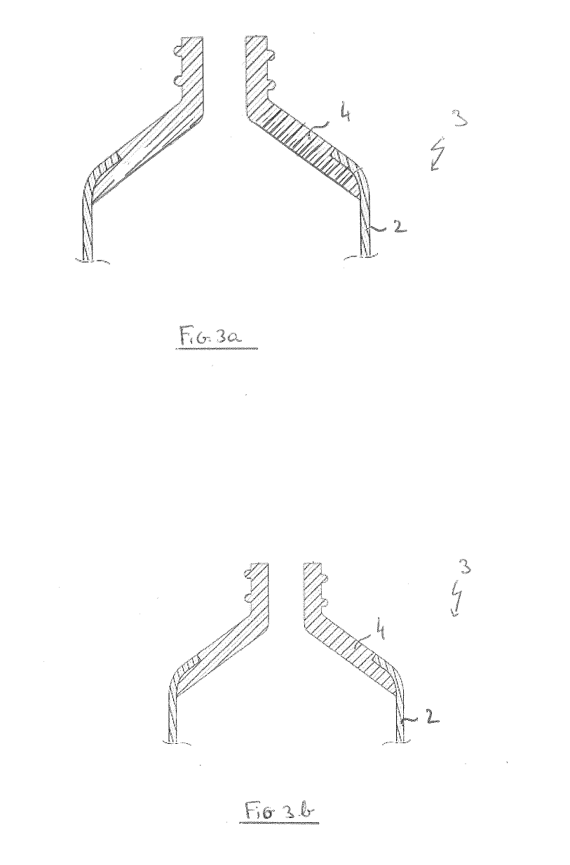

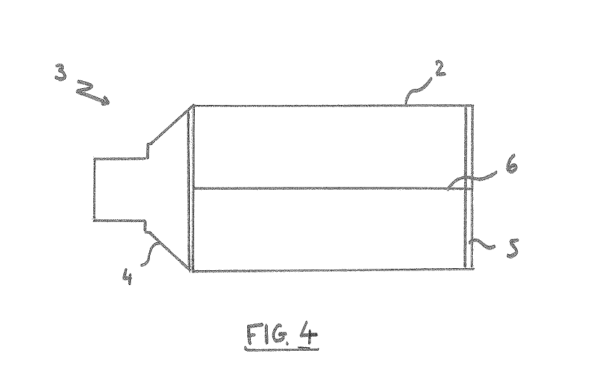

FIG. 4 shows a tube capable of comprising an embodiment of a skirt produced according to an embodiment of the invention.

A multilayer film 1 for a skirt 2 of a flexible tube 3, for example a tube of cream, of which a first end is intended to be closed by a tube head 4, the second end 5 being intended to be heat-sealed after the tube 3 is filled, will now be described with reference to the appended drawings.

The multilayer film 1 comprises at least a first layer 10, known as the inner layer 10, and a second layer 20, known as the outer layer 20, which are adapted to be placed in contact and heat-sealed together along the length of a longitudinal seal line 6 when the skirt 2 of the tube 3 is formed.

The inner layer 10, intended to be positioned on the inside of the skirt 2 once the latter has been formed, comprises a polymer (or a blend of polymers) with a high Young's modulus, namely of at least 1600 MPa. Young's modulus is a measure of stiffness defined by the ratio of stress over strain. It may be experimentally determined by known methods including mechanical analysis such as indentation testing and/or may be calculated based on published materials data values for the raw materials. Where blends are used, the value is calculated based on the weight percent of the ingredients. Polymer layers may be characterised using known techniques, for example Fourier Transform Infra Red transmission (FTIR) and Attenuated Total Reflectance (ATR), Micro Raman spectroscopy, Differential Scanning calorimetry (DSC).

The polymer with a high Young's modulus can be a cyclic olefin copolymer (COC), cyclic olefin polymer (COP), polystyrene (PS), polyamide (PA), polylactic acid (PLA), polyhydroxyalkanoate (PHA), polyhydroxybutyrate (PHB), poly(butylene succinate) (PBS), etc.

The polymer (or blend of polymers) of the inner layer 10 also has good heat-sealing properties, in other words it enables a permanent joint to be made via local heating in order to ensure continuity of the layers to be joined. In particular, where the multilayer film 1 is folded in such a way as to form the skirt 2, and where its longitudinal sides overlap and are heat-sealed together along the longitudinal seal line 6 (a lap seal), the inner layer 10 and the outer layer 20 must be capable of merging and interpenetrating along the length of said seal line 6.

Here, the polymer will be deemed to have good heat-sealing properties where its heat-sealing properties are close to those of polyethylene and polypropylene, and where its melting temperature is not more than 40° C. higher than the normal temperature for heat-sealing these materials, in other words, at not more than 200° C.

According to one embodiment, the polymer (or blend of polymers) is also compatible with polyolefins such as polyethylene (PE), polyethylene copolymers, polypropylene (PP) and polypropylene copolymers, in other words there is no adverse effect on good cohesion within the layer with these materials, in order to minimise the risk of weakening the layer (and thus of cracking it). For example, the inner layer 10 may comprise a blend of high-density polyethylene (HDPE), which is a polyolefin with good heat-sealing properties, with a cyclic olefin copolymer (COC), which is a polymer with a high Young's modulus and is compatible with polyolefins.

As a variant or in combination, the inner layer 10 may be made from a first sub-layer 12, comprising the polymer with a high Young's modulus (such as COC), onto which is fixed a second sub-layer 14, made of a material with good heat-sealing properties (such as HDPE).

According to one embodiment, the inner layer 10 additionally comprises a sealant (also known as a sealing agent), for example polyethylene (PE) or polypropylene (PP).

In addition, depending on the polymers that constitute the inner layer 10, the latter may also comprise in a known manner a compatibility agent, in other words a polymeric interface agent adapted to facilitate the formation of uniform blends of polymers that are normally non-miscible, in order to improve cohesion within the blend of polymers constituting the inner layer 10.

The outer layer 20 is formed from a biaxially-oriented film made of a material capable of being heat-sealed to the material constituting the inner layer 10, in other words whose heat-sealing properties are overall close to those of polyethylene and polypropylene, and whose melting temperature is not more than 40° C. higher than the normal heat-sealing temperature for these materials, i.e. not more than about 200° C. For example, the outer layer 20 may be made of oriented polypropylene (OPP), polyimide (PA), polyethylene terephthalate (PET), polyacrylonitrile (PAN), polyester naphthalate (PEN), polycarbonate (PC) or any multilayer of biaxially-oriented materials, the outer layer of which is adjacent to the outer surface of the film and is capable of being heat-sealed to the material constituting the inner layer 10. A multilayer of this kind may, in particular, be obtained by a double- or triple-bubble extrusion blow-moulding process.

According to one embodiment, the polymer of the inner layer 10 and the biaxially-oriented film of the outer layer 20 are chosen so that, once the inner layer 10 is heat-sealed to the outer layer 20, the seal line 6 resists high levels of tensile stress.

In order to determine the strength of the seal line, a tensile strength test, for example, can be performed on said seal line 6.

For this test, for instance, the free end of a film made of the material constituting the inner layer 10 is sealed to the free end of a film made of the material constituting the outer layer 20 along a longitudinal strip approximately 1.5 mm wide, so as to simulate the lap seal of the skirt 2, and tensile stress is applied in the direction transverse to the seal line 6 of the two films 10, 20.

The seal may, for example, be produced by thermal impulse heat-sealing (about four to five impulses per seal line). In addition, the tensile stress is applied transversely to the seal line 6 at a speed of 100 mm/min.

The force applied to the films at the breaking point is then measured.

For example for two oriented polypropylene (OPP) films heat-sealed to one another (such as Bicor™ 19MB440, which is a film comprising at least one layer of biaxially-oriented transparent polypropylene and at least one layer of polyethylene (outer layer), 19 microns thick offered by Exxon Mobil), the measured force is 570 grams force (on average over several tests). Furthermore, the failure pattern is a loss of cohesion between the layers. The seal line 6 of these films therefore does not resist tensile stress well, because of its failure pattern and because of the average value of the force required to make it fail.

As a comparison, for an oriented polypropylene (OPP) film (such as Bicor™ 19MB440) heat-sealed to a film comprising a blend of polyethylene (PE) and cyclic olefin copolymer (COC) (30% Dow Elite 5940 low-density polyethylene, 30% Dow Elite 5960 high-density polyethylene and 40% Topas® COC 8007—where the Topas® COC 8007 includes at least cyclic olefin copolymer and is offered by Topas), the measured force is approximately equal to 706 grams force and the failure pattern is a failure at the seal line 6. The seal line 6 of these films therefore resists tensile stress well, given its failure pattern and the force required to produce this failure.

In general, it is considered that the seal line 6 has good resistance to tensile stress if the force required to make it fail is a minimum of 650 grams force on average, and/or its failure pattern is an outright failure and not a loss of cohesion between the layers.

The inner layer 10 and the outer layer 20 are separated by a binder, for example an extrusion binder, such as ethylene acrylic acid (EAA), ethylene methacrylate (EMA), ethylene ethyl acrylate (EEA), ethylene maleic anhydride copolymers, acrylic derivatives, maleic anhydride grafted polyolefins, etc.

The multilayer film may also include one or more intermediate layers 30, running between the inner layer 10 and the outer layer 20.

In the examples described below, the intermediate layers 30 include, in particular, a layer forming a barrier to gases, flavours and/or smells, such as aluminium foil, a layer of polyester coated with a ceramic layer forming a barrier (silicon oxide (SiOx) or aluminium oxide (AlOx) in particular), etc. or any biaxially-oriented film forming a barrier, for example films containing a layer of ethylene alcohol copolymer (EVOH).

Each layer is also usually separated from its adjacent layers by binders to facilitate their cohesion within the multilayer film, in accordance with standard techniques. Their respective thicknesses are from 5 to 200 microns.

The thickness of the multilayer film is therefore in the range between 130 μm and 500 μm.

Tables 1.1, 1.2 and 1.3 show examples of multilayer films for tubes 38 mm in diameter and 150 mm long.

More specifically, table 1.1 shows a multilayer film according to the prior art serving as an example for comparison: the outer layer 20 includes polyethylene, and so the Young's modulus is average, approximately 900 MPa.

TABLE 1.1
Multilayer film no. 1

| layer no. | | | | | |
|---|---|---|---|---|---|
| from inner | | | | | |
| layer 10 | | Thick- | Young's | | |
| to outer | | ness | modulus | Poisson's | Density |
| layer 20 | Material | (mm) | E (MPa) | ratio v | (g/cm³) |
| 1 | Polyethylene | 0.07 | 931.00 | 0.30 | 0.96 |
| | (PE) | | | | |
| 2 | PRIMACOR ™ | 0.02 | 700.00 | 0.30 | 0.93 |
| | 3330 (EAA) | | | | |
| 3 | Aluminium foil | 0.01 | 12411.00 | 0.34 | 2.70 |
| | 1145 - O | | | | |
| 4 | PRIMACOR ™ | 0.02 | 700.00 | 0.30 | 0.93 |
| | 3330 (EAA) | | | | |
| 5 | Polyethylene | 0.08 | 931.00 | 0.30 | 0.96 |
| | (PE) | | | | |

Primacor™ 3330 includes at least ethylene copolymer and acrylic acid and is offered by Dow Chemical.

The features of a skirt (cylindrical envelope) formed by longitudinal heat-sealing of multilayer film no. 1 are as shown in table 2.1 below.

TABLE 2.1
Skirt no. 1

| | |
|---|---|
| Thickness of multilayer film | 200.00 |
| (μm) | |
| Mass (g) | 3.79 |
| Neutral line (mm) | −2.04 |
| Elongation strength (N · mm) | 314.72 |
| Flexural strength (N · mm) | 0.62 |
| Coupling strength (N) | −0.64 |
| Poisson's coefficient v | 0.31 |
| Maximum deflection (mm) | −1.99 |
| Overall stiffness (N/mm) | 0.50 |

Here, the neutral line is a line of zero stress within the multilayer film 1, the position of which is calculated in relation to the geometric centre of the film 1.

In addition, the flexural strength is calculated conventionally, by applying point loads of 1 Newton to the skirt 2.

Tables 1.2 and 1.3 show some embodiments of multilayer films according to two embodiments of the invention.

TABLE 1.2
Multilayer film no. 2

| layer no. | | | | | |
|---|---|---|---|---|---|
| from inner | | | | | |
| layer 10 | | Thick- | Young's | | |
| to outer | | ness | modulus | Poisson's | Density |
| layer 20 | Material | (mm) | E (MPa) | ratio v | (g/cm³) |
| 1 | Blend: | 0.06 | 1600.00 | 0.30 | 1.00 |
| | HDPE: 70% | | | | |
| | TOPAS ® 8007 | | | | |
| | (COC): 30% | | | | |
| 2 | PRIMACOR ™ | 0.02 | 700.00 | 0.30 | 0.93 |
| | 3330 (EAA) | | | | |
| 3 | Aluminium foil | 0.01 | 12411.00 | 0.34 | 2.70 |
| | 1145 - O | | | | |
| 4 | PRIMACOR ™ | 0.02 | 700.00 | 0.30 | 0.93 |
| | 3330 (EAA) | | | | |
| 5 | Polyethylene | 0.03 | 931.00 | 0.30 | 0.96 |
| | (PE) | | | | |
| 6 | Bicor ™ | 0.02 | 3500.00 | 0.30 | 0.91 |
| | 15MB440 (OPP) | | | | |

Bicor™ 15MB440 is a film comprising at least one layer of biaxially-oriented transparent polypropylene and at least one layer of polyethylene (outer layer), 15 microns thick, offered by Exxon Mobil.

The inner layer 10 of multilayer film no. 2 comprises a blend of high-density polyethylene (HDPE) and cyclic olefin copolymer (COC) (in a 70/30 ratio), in order to combine the heat-sealing properties of HDPE with the mechanical strength of COC.

TABLE 1.3
Multilayer film no. 3

| layer no. | | | | | |
|---|---|---|---|---|---|
| from inner | | | | | |
| layer 10 | | Thick- | Young's | | |
| to outer | | ness | modulus | Poisson's | Density |
| layer 20 | Material | (mm) | E (MPa) | ratio v | (g/cm³) |
| 1 | Polyethylene | 0.01 | 931.00 | 0.30 | 0.96 |
| | (PE) | | | | |
| 2 | TOPAS ® 8007 | 0.04 | 2600.00 | 0.30 | 1.02 |
| | (COC) | | | | |
| 3 | PRIMACOR ™ | 0.02 | 700.00 | 0.30 | 0.93 |
| | 3330 (EAA) | | | | |
| 4 | Aluminium foil | 0.01 | 12411.00 | 0.34 | 2.70 |
| | 1145 - O | | | | |
| 5 | PRIMACOR ™ | 0.02 | 700.00 | 0.30 | 0.93 |
| | 3330 (EAA) | | | | |
| 6 | Polyethylene | 0.03 | 931.00 | 0.30 | 0.96 |
| | (PE) | | | | |
| 7 | Bicor ™ | 0.02 | 3500.00 | 0.30 | 0.91 |
| | 15MB440 (OPP) | | | | |

In this embodiment, on the other hand, the inner layer 10 of multilayer film no. 3 consists of two superposed sub-layers 12, 14, a first sub-layer 12 comprising polyethylene (PE), which has good heat-sealing properties, whereas a second sub-layer 14 comprises a cyclic olefin copolymer (COC), which has good mechanical strength and a high Young's modulus. The layer of HDPE is then adjacent to the inner surface 10 of the film in such a way as to enter into direct contact with the outer layer 20 during heat-sealing.

The features of the skirts (cylindrical envelope) formed by longitudinal heat-sealing of multilayer films no. 2 and no. 3 are as set out below in tables 2.2 and 2.3 respectively:

TABLE 2.2
Skirt no. 2

| | |
|---|---|
| Thickness of multilayer film | 159.00 |
| (μm) | |
| Mass (g) | 3.11 |
| Neutral line (mm) | 5.59 |
| Elongation strength (N · mm) | 364.16 |
| Flexural strength (N · mm) | 0.65 |
| Coupling strength (N) | 2.04 |
| Poisson's coefficient v | 0.31 |
| Maximum deflection (mm) | −1.72 |
| Overall stiffness (N/mm) | 0.5827 |

TABLE 2.3
Skirt no. 3

| | |
|---|---|
| Thickness of multilayer film | 151.00 |
| (μm) | |
| Mass (g) | 2.98 |
| Neutral line (mm) | 0.65 |
| Elongation strength (N · mm) | 384.67 |
| Flexural strength (N · mm) | 0.63 |
| Coupling strength (N) | 0.25 |
| Poisson's coefficient v | 0.31 |
| Maximum deflection (mm) | −1.72 |
| Overall stiffness (N/mm) | 0.5830 |

Skirts no. 2 and no. 3, made with multilayer films no. 2 and no. 3 in accordance with the embodiments given in tables 1.2 and 1.3, are not as thick (159 μm and 151 μm respectively) as skirt no. 1 in the comparison sample, and their overall stiffness (defined by the ratio of the maximum deflection of the film and the load applied) is greater (0.21 N/mm as against 0.18 N/mm). The flexural strength of these skirts is also greater in comparison with the flexural strength of skirt no. 1.

Thus, in comparison with conventional seals in which there are sealed, for example, two layers of biaxially-oriented polypropylene (OPP), each therefore having a thin layer of polyethylene (PE) on the surface, the replacement of a layer of OPP by a layer comprising polyethylene and a material with a high Young's modulus (for example, TOPAS® 8007 (COC)) makes it possible to improve the seal, at equal (or even lower) levels of strength, stiffness and thickness of the final multilayer film. For this reason, the heat-sealing layer is thicker in comparison with heat-sealing layers of the prior art, and consequently provides more material so that the heat-seal is stronger and of better quality.

In general, a multilayer film formed of layers of PE/OPP/PE/EAA/Alu/EAA/COC fulfils the conditions laid down by the invention so that, for the same thickness, each of these films has greater stiffness and better heat-sealing properties than conventional films.

According to a preferred embodiment, the multilayer film may include the following layers: PE/OPP/LDPE/EAA/Alu/EAA/blend (HDPE+COC).

For example, the multilayer film may include the following layers:
* PE/OPP/LDPE/EAA/Alu/EAA/blend (70% HDPE+30% COC)
* PE/OPP/LDPE/EAA/Alu/EAA/blend (55% HDPE+15% LLDPE+30% COC)

Tables 3.1 to 3.6 are examples of such multilayer films according to the invention.

TABLE 3.1
Multilayer film no. 4

| layer no. | | |
|---|---|---|
| from the outer | | |
| layer | | Thickness |
| to the inner layer | Material | (mm) |
| 1 | Bicor ™ 19 MB440 (OPP) | 0.019 |
| 2 | Blend 70% Exact ® 8210 + 24% | 0.050 |
| | LDPE + 6% White | |
| 3 | EAA + 3% White | 0.020 |
| 4 | Aluminium foil | 0.012 |
| 5 | PRIMACOR ™ 3330 (EAA) | 0.020 |
| 6 | Blend 70% HDPE + 30% | 0.050 |
| | TOPAS ® COC - binder | |

Exact® 8210 film includes at least ethylene octene copolymer and is offered by Exxon Mobil.

The White is a master blend comprising polyethylene and a filler such as TiO₂.

TOPAS® COC comprises at least cyclic olefin copolymer and is offered by the supplier Topas.

The final thickness of multilayer film no. 4 is in this case around 171.6 microns.

TABLE 3.2
Multilayer film no. 5

| layer no. | | |
|---|---|---|
| from the outer | | |
| layer | | Thickness |
| to the inner layer | Material | (mm) |
| 1 | Bicor ™ 19 MB440 (OPP) | 0.019 |
| 2 | Blend 70% Exact ® 8210 + 24% | 0.040 |
| | LDPE + 6% White | |
| 3 | EAA + 3% White | 0.020 |
| 4 | Aluminium foil | 0.012 |
| 5 | PRIMACOR ™ 3330 (EAA) | 0.020 |
| 6 | Blend 70% HDPE + 30% | 0.050 |
| | TOPAS ® COC - binder | |

The final thickness of multilayer film no. 5 is around 151.0 microns.

TABLE 3.3
Multilayer film no. 6

| layer no. | | |
|---|---|---|
| from the outer | | |
| layer | | Thickness |
| to the inner layer | Material | (mm) |
| 1 | Bicor ™ 19 MB440 (OPP) | 0.019 |
| 2 | Blend 70% Exact ® 8210 + 24% | 0.040 |
| | LDPE + 6% White | |
| 3 | EAA + 3% White | 0.020 |
| 4 | Aluminium foil | 0.012 |
| 5 | PRIMACOR ™ 3330 (EAA) | 0.020 |
| 6 | Blend 70% HDPE + 30% | 0.048 |
| | TOPAS ® COC - binder | |

The final thickness of multilayer film no. 6 is around 159.0 microns.

TABLE 3.4
Multilayer film no. 7

| layer no. | | |
|---|---|---|
| from the outer | | |
| layer | | Thickness |
| to the inner layer | Material | (mm) |
| 1 | Bicor ™ 19 MB440 (OPP) | 0.019 |
| 2 | Blend 70% Exact ® 8210 + 24% | 0.040 |
| | LDPE + 6% White | |
| 3 | EAA + 3% White | 0.020 |
| 4 | Aluminium foil | 0.0089 |
| 5 | PRIMACOR ™ 3330 (EAA) | 0.020 |
| 6 | Blend 70% HDPE + 30% | 0.044 |
| | TOPAS ® COC - binder | |

The final thickness of multilayer film no. 7 is around 151.9 microns.

TABLE 3.5
Multilayer film no. 8

| layer no. | | |
|---|---|---|
| from the outer | | |
| layer | | Thickness |
| to the inner layer | Material | (mm) |
| 1 | Bicor ™ 19 MB440 (OPP) | 0.019 |
| 2 | Blend 70% Exact ® 8210 + 24% | 0.040 |
| | LDPE + 6% White | |
| 3 | EAA + 3% White | 0.020 |
| 4 | Aluminium foil | 0.009 |
| 5 | PRIMACOR ™ 3330 (EAA) | 0.020 |
| 6 | Blend 70% HDPE 30% | 0.048 |
| | TOPAS ® COC - binder | |

The final thickness of multilayer film no. 8 is around 156.0 microns.

TABLE 3.6
Multilayer film no. 9

| layer no. | | |
|---|---|---|
| from the outer | | |
| layer | | Thickness |
| to the inner layer | Material | (mm) |
| 1 | Bicor ™ 19 MB440 (OPP) | 0.019 |
| 2 | Blend 70% Exact ® 8210 + 24% | 0.040 |
| | LDPE + 6% White | |
| 3 | EAA + 3% White | 0.020 |
| 4 | Aluminium foil | 0.009 |
| 5 | PRIMACOR ™ 3330 (EAA) | 0.020 |
| 6 | Blend 55% HDPE 15% | 0.04 |
| | LLDPE 30% TOPAS ® COC - | |
| | binder | |

The final thickness of multilayer film no. 9 is around 156.0 microns.

A multilayer film such as those described in the embodiments above may be obtained, in particular, via a conventional coextrusion coating and laminating machine.

For instance, in the case of multilayer films nos. 2 and 3, the layer of biaxially-oriented polypropylene (OPP) and the layer of aluminium are taken into the machine in the form of films that are stored on reels.

The reels are then unrolled in an opposed manner so as to leave a space between the films that is intended to receive the intermediate layers 30 (including, in this example, a layer of polyethylene (PE) and a layer of ethylene acrylic acid (EAA)). The intermediate layers are then formed via an extruding machine adapted to cause melting of the materials constituting the layers, which are then laid down using a die between the OPP and aluminium films. The layers formed in this way are then joined together, for example by colamination or any other method that allows adjustment of a joining pressure on the layers. There is then obtained a first multilayer film, formed successively from the layer of biaxially-oriented polypropylene (OPP), a layer of polyethylene (PE), a layer of ethylene acrylic acid (EAA) and the layer of aluminium.

The remaining layers are then laid down, namely, in this case, the layer of ethylene acrylic acid (EAA) and the inner layer 10 (comprising either the blend of high-density polyethylene (HDPE) and cyclic olefin copolymer (COC) for film no. 2, or the superposed sub-layers 12, 14 of polyethylene (PE) and cyclic olefin copolymer (COC) for film no. 3) on this first multilayer film in order to obtain the final multilayer film 1.

The tube 3 is then obtained by fixing a tube head 4 onto the skirt 2 thus formed, as illustrated in FIGS. 3a and 3b.

For example, the tube head 4 can be made separately, by injection moulding (injection of material into a mould) or by compression (compression of material in a mould), in order to be joined subsequently to one of the open ends of the skirt 2 by heat-sealing or by induction sealing. As a variant, the tube head 4 may also be directly moulded onto the skirt (by injection moulding of the constituent material onto one of the open ends of the skirt 2).

Use of the term “layer” herein includes such a layer being formed from one or more sub-layers. Whilst the arrangement of layers has been described with reference to an inner layer, which is product facing, and an outer layer, this notation is used only in a relative sense and could alternatively be described as a first layer to an n^{th} layer, where the first layer is the inner layer, the n^{th} layer is the outer layer (and n is the number of layers and/or the number of layers and sub-layers).

Of course, the present invention is not in any way limited to the embodiments described above and shown in the drawings, but a person skilled in the art will be capable of making several variations thereof and modifications thereto.

1. Multilayer film (1) for a skirt (2) of a flexible tube (3) one end of which is intended to be closed by a tube head (4), said multilayer film being intended to be folded on itself and heat-sealed along the length of a longitudinal seal line (6) in such a way as to form the skirt (2) so that a first layer (10) of the multilayer film (1), known as the inner layer, is heat-sealed to a second layer (20) of the multilayer film (1) opposite the first layer, known as the outer layer, characterised in that:
the inner layer (10) comprises a polymer or a blend of polymers with a Young's modulus of at least 1600 MPa, and
the outer layer (20) is made of a biaxially-oriented film.

2. Multilayer film (1) according to claim 1, in which the polymer or the blend of polymers and the biaxially-oriented film are chosen so that, once the inner layer (10) has been heat-sealed to the outer layer (20), the seal line (6) resists high levels of tensile stress.

3. Multilayer film (1) according to claim 1, in which the polymer or the blend of polymers also has good heat-sealing properties.

4. Multilayer film (1) according to claim 1, in which the polymer or the blend of polymers is also compatible with polyolefins such as polyethylene (PE), polyethylene copolymers, polypropylene (PP) and polypropylene copolymers, in order to minimise the risk of weakening (and therefore cracking) the layer.

5. Multilayer film (1) according to claim 1, in which the polymer or the blend of polymers includes at least one of the following materials: cyclic olefin copolymer (COC), cyclic olefin polymer (COP), polystyrene (PS), polyamide (PA), ethylene vinyl acetate copolymer (EVA), ethylene methacrylate copolymer (EMA), polylactic acid (PLA), polyhydroxyalkanoate (PHA), polyhydroxybutyrate (PHB), poly(butylene succinate) (PBS).

6. Multilayer film (1) according to claim 1, in which the inner layer (10) includes a blend of a polymer possessing good heat-sealing properties with a polymer or a blend of polymers that has a Young's modulus of at least 2000 MPa.

7. Multilayer film (1) according to claim 6, comprising the following successive layers, from the inner layer (10) to the outer layer (20): a blend of a high-density polyethylene (HDPE) and a cyclic olefin copolymer (COC) (10), binder, aluminium foil, binder, polyethylene (PE), biaxially-oriented film such as an oriented polypropylene (OPP) (20).

8. Multilayer film (1) according to claim 1, in which the inner layer (10) consists of a first sub-layer (12), produced from a material with good heat-sealing properties, and of a second sub-layer (14), comprising a polymer or a blend of polymers with a Young's modulus of at least 1600 MPa.

9. Multilayer film (1) according to claim 8, comprising the following successive layers, from the inner layer (10) to the outer layer (20): polyethylene (PE) (12), cyclic olefin copolymer (COC) (14), binder, aluminium foil, binder, polyethylene (PE), biaxially-oriented film such as an oriented polypropylene (OPP) (20).

10. Multilayer film (1) according to claim 1, in which the binder is an extrusion binder, for example ethylene acrylic acid (EAA), ethylene methacrylate (EMA), ethylene ethyl acrylate (EEA), ethylene maleic anhydride copolymers, acrylic derivatives, or maleic anhydride grafted polyolefins.

11. Multilayer film (1) according to claim 1, in which the outer layer (20) is made of one of the following materials: oriented polypropylene (OPP), polyamide (PA), polyethylene terephthalate (PET), polyacrylonitrile (PAN), polyester naphthalate (PEN), polycarbonate (PC) or any multilayer of biaxially-oriented materials with an outer layer (20) capable of being heat-sealed to the material constituting the inner layer (10).

12. Skirt (2) of a flexible tube (3) of which one end is intended to be closed by a tube head (4), a tube of cream for example, characterised in that it is made of a multilayer film (1) according to claim 1.

13. Flexible tube (3), for example for the storage and distribution of liquid to pasty products, characterised in that it comprises a skirt (2) according to claim 12, closed at a first end by a tube head (4), and closed at a second end (5), opposite the first end, by heat-sealing.
